(19) United States
(12) Patent Application Publication
(10) Pub. No.: US 2001/0051452 A1
(43) Pub. Date: Dec. 13, 2001

(54) Connector mounting apparatus

(76) Inventor: Simon J.E. Walker, Ulverston (GB)

Correspondence Address: Alix, Yale & Ristas, 750 Main Street, Hartford, CT, 06103-2721, US

(21) Appl. No.: 09/827,592

(22) Filed: Apr. 6, 2001

Related U.S. Application Data
(60) Provisional application No. 60/207,610, filed on May 26, 2000.

(30) Foreign Application Priority Data
Apr. 6, 2000 (GB) GB0008523.3

(51) Int. Cl. H01R 13/64

(52) U.S. Cl. 439/248

(57) ABSTRACT

Apparatus for mounting a connector part of a connector for use in an underwater or severe environment to an installation, the apparatus being adapted to be secured at a radially inner region thereof to the connector part and at a radially outer region thereof to the installation, and the apparatus comprising a flexible portion extending in the circumferential direction for providing compliance between the connector part and the installation.

### FIELD OF THE INVENTION

The present invention relates to apparatus for mounting a connector part to an installation, the connector part being part of a connector for use in an underwater or severe environment and for the transmission of electrical, optical, hydraulic, air, or other services.

### BACKGROUND OF THE INVENTION

It is known in the oil industry to connect up services at underwater sites such as a wellhead installed on the sea bed. It is known from GB-A-2192316 to provide an underwater electrical connector having a first part provided with a mating receptacle surrounding a set of electrical contact pins and a second part provided with a mating plug which houses a corresponding set of electrical contact terminals. The plug has a cylindrical outer surface designed to fit precisely in the receptacle which is also cylindrical, there being a pin and keyway arrangement to ensure correct circumferential alignment between the parts. In use, the first part of the connector is normally secured to a sea bed installation and the second part is mated with the first part by a diver who inserts the plug into the socket, whereby the contact pins make electrical connect with the contract terminals.

In some circumstances, for example in deep water, it may be preferred to use a remotely operated vehicle (ROV) rather than a diver to make the connection. Where either a diver or an ROV is used to make the connection, forces are exerted on the first part of the connector which is secured to a seabed installation when the second part is mated with the first part. These may be relatively large in the case of an ROV. Consequently, it is desirable to provide a degree of compliance in the means for securing the first part of the connector to the seabed installation.

A known apparatus for mounting a part of a connector to a subsea or severe environment installation is disclosed in International patent application No. WO92/12554. As described in this application, and shown in FIGS. 14 and 15 thereof, the system for mounting the part of the connector to a bulkhead of the installation is in the form of four mounting bolts, each bolt passing through aligned apertures in the bulkhead and in an annular flange around the connector part. Each bolt has a bolt head which provides a seat for a spring. The spring biases a conical washer against a complementary conical surface on a bush located in the aperture of the connector part flange. The provision of spring loaded washers in this system allows for a degree of movement between the connector part and the installation.

The springs used in the system of the prior art are specialist high strength, corrosion resistant springs. Consequently the cost of the springs together with the high machining costs of the prior art system increase the cost of producing the mounting apparatus. In addition, several different parts are involved. Consequently, the present invention seeks to provide an apparatus for mounting a connector part to an installation in which the manufacture of the apparatus is simplified so as to reduce the costs involved.

### SUMMARY OF THE INVENTION

Thus, viewed from a first aspect, the present invention provides an apparatus for mounting a connector part of a connector for use in an underwater or severe environment to an installation, the apparatus being adapted to be secured at a radially inner region thereof to the connector part and at a radially outer region thereof to the installation, and the apparatus comprising a flexible portion extending in the circumferential direction for providing compliance between the connector part and the installation.

By providing a circumferentially extending flexible portion, the desired compliance can be achieved in a simplified manner. The flexible portion is preferably made from a resilient material, more preferably an elastomeric material, such as rubber, e.g. nitrile rubber or hydrogenated nitrile rubber. A resilient flexible portion can enable the mounting apparatus to centre the connector part during the mating process with another connector part carried by an ROV or diver.

The flexible portion may extend in the circumferential direction only partly around the mounting apparatus. For example, a horse-shoe shaped (when viewed axially) flexible portion may facilitate assembly of the apparatus on to the connector part. In a preferred embodiment, the flexible portion extends in the circumferential direction to form an endless ring. Such a ring is preferably generally circular when viewed axially, but other shapes such as square or oval are possible, particularly if the mounting apparatus is for use with a connector part which has a non-circular outer periphery.

The mounting apparatus may comprise a plurality of radially adjacent components. Such components may be generally ring shaped or circular in form, although the exact shape will depend on the external shape of the connector part.

Preferably, radially adjoining edges of radially adjacent components are profiled so as to prevent relative movement of the component in at least one axial direction. This can reduce reliance on e.g. an elastomer to metal bond. If the securing arrangements are such as to apply an axial force to a component, for example by the tightening of one or more bolts, then the profiling can be such as to prevent relative movement of the components in the appropriate axial direction. In some cases, it may be desired for the profiling to resist relative movement in both axial directions.

Preferably, the apparatus comprises a first, radially inner component to be secured to the connector part, and a second component located outwardly of the first component, one of the first and second components comprising said flexible portion. The first component may comprise the flexible portion, and the second component may be substantially rigid. It is however preferred for the first component to be substantially rigid, e.g. metallic. It can then be secured rigidly to the connector. The second component then comprises the flexible portion for providing compliance.

The first component preferably has an outer diameter larger than that of a hole in e.g. a bulkhead through which a connector mounted by the apparatus will extend. There may be a radially outward protrusion providing this larger diameter. Thus, if the first and second components become detached during the service life of the mounting apparatus, the first component cannot pass through the hole in the bulkhead.

In one form of the mounting apparatus the second component is to be secured directly to the installation. It may for example be provided with apertures for receiving bolts, whereby the second component can be bolted to the installation. Preferably, a substantially rigid, e.g. metallic, insert is provided in each of the apertures, for example a bush bonded to the material forming the second component. Such an insert can serve to reinforce the aperture and/or be formed with a thread for engagement by a respective bolt.

In another form of the mounting apparatus in which the first component is substantially rigid and the second component comprises the flexible portion, there may be provided a third, substantially rigid component located outwardly of the second component and to be secured to the installation. Such an arrangement is beneficial in that the design of the second component can be optimised to achieve the desired compliance, with the first and third components taking care of the requirements of securing to the connector part and installation respectively. Preferably, apertures for receiving bolts are provided in the third component, whereby the third component can be bolted to the installation.

It is also preferred for the first and third components to have respective portions which overlap when viewed in the axial direction. Thus, in the event that the second component becomes lost at some stage during the service life of the mounting apparatus, the overlap can prevent the first component from being able to pass through the third component. The first component may be provided with a radially protruding portion which overlaps with a radially inwardly protruding portion of the third component. The portion of the first component providing the overlap may also serve to prevent the first component from being able to pass through a hole in a bulkhead to which the mounting apparatus is secured in use.

A component comprising the flexible portion may be moulded on to a one piece substantially rigid component. Such moulding can provide a bond between the components. In some circumstances, it may be preferred to mould a component separately of a substantially rigid component with which it will be radially adjacent in the assembled apparatus. At least one of the components may be formed in two or more segments to enable ease of assembly of the apparatus. Such an arrangement may be particularly useful in the case of apparatus having first, second and third components as discussed above. For example, either the first (radially inner) component or the third (radially outer) component may be formed as a plurality, preferably two, segments, e.g. a split ring. In one possible arrangement, the third component is formed as plural segments, as this may ease the attachment of the mounting apparatus to an installation.

If the flexible portion of the apparatus is made of a suitable material, e.g. an elastomer, it may provide electrical isolation of the connector part from the installation. As is known in the art, subsea installations are generally cathodically protected by being held at a negative potential and by being provided with sacrificial anodes so that the anodes will corrode in the place of the installation. Salts produced from the corrosion of the anodes will build up on the installation. Consequently, if the connector part is at the same potential as the installation, a build up of salts will also occur on the connector part. However, this is disadvantageous as the connector part may become increasingly difficult to mate or demate due to the build up of salts thereon. Thus, it is important to electrically isolate the connector part from the installation so that the connector part retains a neutral charge and no salts build up on the connector.

This is achieved in the prior art by means of insulating sheaths surrounding the bolts which attach the flange on the connector part to the bulkhead of the installation, together with an insulating spacer disposed between the flange and the bulkhead. However, with preferred embodiments of the present invention, in which the flexible portion also acts as an electrical insulator, it is not necessary to provide the insulating sheaths and spacer. In the above arrangement, a component (e.g. the previously described second or third component) may therefore be in direct contact with the installation, there being no intervening insulating spacer. Another component (e.g. the previously described first, radially inner component to be secured to the connector part) is preferably arranged to avoid contact with the installation, so that it can be electrically isolated therefrom.

Preferably, at least two of the components have axially facing surfaces which are axially offset from each other. Thus, a radially outer component may have a surface in contact with the installation, whilst a radially inner component which is in contact with the connector may have a surface axially offset away from the plane of contact between the radially outer component and the installation. This can ensure that the radially inner component, and hence the connector part, is electrically isolated from the installation.

The provision of electrical isolation as described herein is believed to be inventive in its own right. Thus, viewed from a second aspect, the present invention provides apparatus for mounting a connector part of a connector for use in an underwater or severe environment to an installation, the apparatus being adapted to be secured at a radially inner region thereof to the connector part and at a radially outer region thereof to the installation, and comprising an electrically insulating component extending in the circumferential direction and interposed radially between the inner and outer securing regions for electrically isolating the connector part from the installation.

### BRIEF DESCRIPTION OF THE DRAWINGS

Preferred embodiments of the invention will now be described by way of example only and with reference to the accompanying drawings in which:

FIG. 1 is a cross section taken transverse to a central axis of mounting apparatus according to a first embodiment of the invention;

FIG. 2 is a cross section along line II-II of the apparatus of FIG. 1;

FIG. 3 is a cross section similar to II-II, but also showing a connector part and a bulkhead of an installation, connected together by the apparatus;

FIG. 4 is a cross section taken transverse to a central axis of mounting apparatus according to a second embodiment of the invention;

FIG. 5 is a cross section along line V-V of the apparatus of FIG. 3; and

FIG. 6 is a cross section similar to V-V, but also showing a connector part and a bulkhead of an installation, connected together by the apparatus.

### DESCRIPTION OF THE PREFERRED EMBODIMENTS

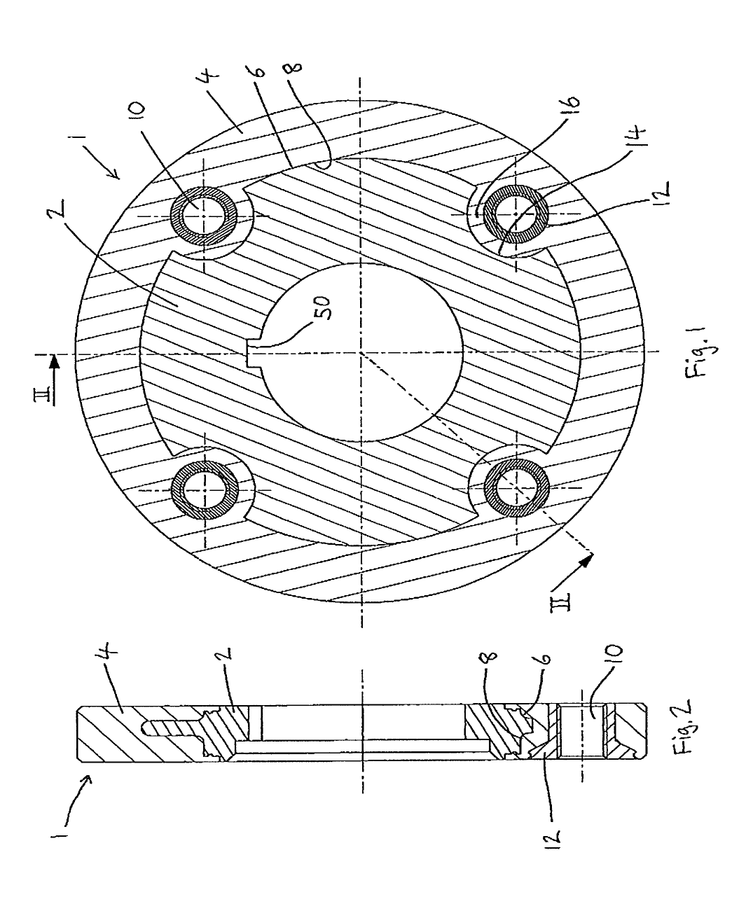

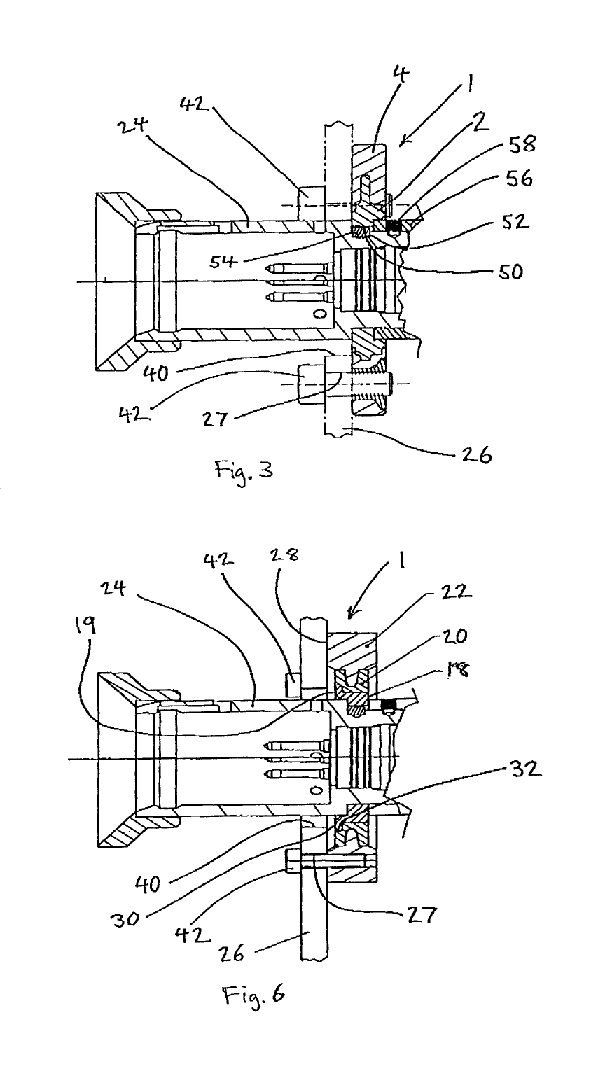

As shown in FIGS. 1, 2 and 3, according to a first embodiment of the invention, the apparatus 1 for mounting a first connector part of an underwater e.g. subsea connector to an underwater installation having a bulkhead comprises a first, radially inner, annular metallic component 2. Examples of suitable metals for this component are stainless steel, aluminium, or bronze. The inner diameter of the inner metallic component 2 corresponds substantially to the diameter of the connector part, as seen in FIG. 3. A second, radially outer, annular elastomeric component 4 of nitrile or hydrogenated nitrile rubber extends around the inner metallic component 2. As can be seen in FIG. 2, the outer edge 6 of the inner metallic component and the inner edge 8 of the outer elastomeric component are profiled so as to prevent relative axial movement in both directions. The components are thereby held together.

Four apertures 10 whose centres are equidistantly spaced at 90° from one another are provided passing through the outer elastomeric component 4. A metal bush 12 lines each of the apertures 10. As seen in FIG. 1, radially inward recesses 14 are provided in the outer edge 6 of the inner metallic component 2 at respective locations corresponding to each of the tour apertures 10. Corresponding radially inward projections 16 on the outer elastomeric component 4 mesh with the recesses 14. In this way, the apertures 10 are entirely surrounded by elastomeric material.

In use, the mounting apparatus is assembled on a connector part 24 so that the connector part is held within the annular components, as shown in FIG. 3. The inner metallic component 2 is formed at its inner edge with a slot 50 which receives a key 52, the key also engaging in a recess 54 formed on the outer surface of the connector part 24, so that the mounting apparatus and the connector part are rotationally fixed relative to each other. A rear housing sleeve 56 is located behind the mounting apparatus and is secured to the receptacle at the front of the connector part 24 by a plurality of grub screws 58 (only one being shown in FIG. 3). The mounting apparatus is thus interposed between the receptacle and the rear housing sleeve 56 so that the connector part is axially fixed relative to the mounting apparatus.

The connector part is arranged so as to extend through a hole 40 in the bulkhead, preferably a circular hole with an inner diameter big enough to give a clearance from the outer periphery of the connector part. The mounting apparatus is bolted to the bulkhead by bolts 42 fed through each of the four apertures 10 and through corresponding apertures 27 in the bulkhead. The mounting of the connector part to the installation in this way will normally be carried out at surface, whereafter the installation may be lowered into position on the seabed. The connector part may be mated with the other connector part, i.e. a plug connector part designed to fit in the receptacle, of the connector either at surface or when underwater. Demating and mating of the connector may subsequently take place underwater, with the first connector part being flexibly supported by the mounting apparatus to assist with these operations.

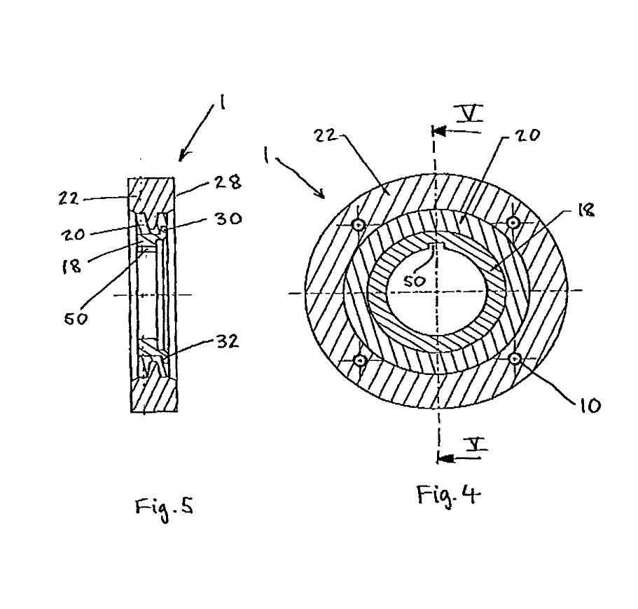

In an alternative embodiment of the apparatus as shown in FIGS. 4-6, the apparatus is again made up of an elastomeric component made of nitrile or hydrogenated nitrile rubber and a metallic component where the same metals as those described in relation to the first embodiment could be used. In this embodiment, the apparatus comprises a first, radially inner, annular metallic component 18, the inner diameter of which corresponds to the diameter of the connector part. A second, annular, elastomeric component 20 is adapted to engage the outer edge of the inner metallic component 18. In this embodiment, the second component is not radially outermost and is instead at an intermediate location, there being a third, radially outer, annular, metallic component 22 which is in turn adapted to engage the outer edge of elastomeric component 20. Four equispaced apertures 10 extend through the outer metallic component 22, for receipt of bolts 42 which secure the mounting apparatus to a bulkhead 26 of an underwater installation. The outer metallic component 22 has an axially forwardly facing surface 28 in abutting contact with a rearwardly facing surface of the bulkhead, whilst the inner metallic component 18 has an axially forwardly facing surface 19 which is axially offset rearwardly of surface 28 so as to be prevented from making contact with the bulkhead 26.

The edges of the components are profiled as in the first embodiment so that the components are held together. The profiling of the outer edge of the inner component 18 and the inner edge of the intermediate component 20 is such as to assist this assembly, whilst also preventing relative axial movement of the components during tightening of the bolts 42. In particular a circumferentially extending lip 30 at the outer edge of component 18 engages in a corresponding recess 32 in the inner edge of component 20, so as to provide an abutment to resist relative axial movement in the one axial direction. The lip 30 also serves to prevent the inner component 18 from being able to pass through the elastomeric component 20 or a hole 40 in a bulkhead 26, and hence the connector part 24 can be retained at least loosely in position in the event that the component 20 is lost.

The mounting apparatus of FIGS. 4-6 is manufactured by moulding the elastomeric component 20 into a gap between the inner and outer metallic components 18, 22. Before moulding, a bonding agent is applied to the outer edge of the inner metallic component 18 to ensure a good bond with the elastomeric component 20. The profiles of the adjoining edges of the elastomeric component 20, and the outer component 22 ensure a good connection and a bonding agent is not necessary.

As with the first embodiment, the assembled components are placed onto a connector part 24 as shown in FIG. 6. The connector part 24 is passed through the hole 40 in the bulkhead 26 until the bulkhead abuts the outer component 22. The bolts 42 are then passed through the apertures 27 in the bulkhead and corresponding apertures 10 in the outer metallic component 22 and tightened so as to hold the connector part to the bulkhead. The bulkhead and connector part are then ready to be lowered to the seabed for use.

The described embodiments of mounting apparatus provide compliance between the connector part and the installation, so that when the other connector part approaches and engages the already installed connector part, the latter may move relative to the installation without unacceptable shock loading. Compliance is provided in the axial direction (i.e. rearward or forward movement of the connector part), in the angular direction (i.e. angular movement of the connector part such that it tilts off the axial direction), and in the rotational direction (i.e. twisting movement of the connector part about the axial direction). The mounting apparatus is capable of allowing ±2 mm axial movement, ±5° angular movement and ±20° rotational movement.

It will be appreciated that in the embodiments of the invention described above, the elastomeric portion of the apparatus provides compliance and electrical insulation between the connector part and bulkhead when connected by the apparatus in use. However, it will be appreciated that there are significant benefits over the prior art, if the material of the second component is selected to provide just one of these properties.

It will also be appreciated that in both embodiments, a receptacle connector part is shown as being provided at a seabed installation, with a plug connector part being carried by an ROV or diver to the installation to make the connection. However, the reverse arrangement of the plug connector part being already installed and the receptacle connector part being transported to the connection site may be preferred in some applications.

In addition, the invention in its different aspects is not limited to the features of the preferred embodiments described above and many modifications could be made to these embodiments which would be within the scope of the invention as claimed.

What is claimed is:

1. Apparatus for mounting a connector part of a connector for use in an underwater or severe environment to an installation, the apparatus being adapted to be secured at a radially inner region thereof to the connector part and at a radially outer region thereof to the installation, and the apparatus comprising a flexible portion extending in the circumferential direction for providing compliance between the connector part and the installation.

2. Apparatus as claimed in claim 1, comprising a plurality of radially adjacent components.

3. Apparatus as claimed in claim 2, wherein radially adjoining edges of radially adjacent components are profiled so as to prevent relative movement of the components in at least one axial direction.

4. Apparatus as claimed in claim 2, comprising a first, radially inner component to be secured to the connector part, and a second component located outwardly of the first component, one of the first and second components comprising said flexible portion.

5. Apparatus as claimed in claim 3, comprising a first, radially inner component to be secured to the connector part, and a second component located outwardly of the first component, one of the first and second components comprising said flexible portion.

6. Apparatus as claimed in claim 4, wherein the first component is substantially rigid and the second component comprises said flexible portion.

7. Apparatus as claimed in claim 5, wherein the first component is substantially rigid and the second component comprises said flexible portion.

8. Apparatus as claimed in claim 6, comprising a third, substantially rigid component located outwardly of the second component and to be secured to the installation.

9. Apparatus as claimed in claim 7, comprising a third, substantially rigid component located outwardly of the second component and to be secured to the installation.

10. Apparatus as claimed in claim 8, wherein apertures for receiving bolts are provided in the third component, whereby the third component can be bolted to the installation.

11. Apparatus as claimed in claim 8, wherein the first and third components have respective portions which overlap when viewed in the axial direction.

12. Apparatus as claimed in claim 10, wherein the first and third components have respective portions which overlap when viewed in the axial direction.

13. Apparatus as claimed in claim 6, wherein apertures for receiving bolts are provided in the second component, whereby the second component can he bolted to the installation.

14. Apparatus as claimed in claim 13, wherein a substantially rigid insert is provided in each of the apertures.

15. Apparatus as claimed in claim 2, wherein at least two of the components have axially facing surfaces which are axially offset from each other.

16. Apparatus as claimed in claim 1, wherein the flexible portion is adapted to electrically isolate the connector part from the installation in use.

17. Apparatus as claimed in claim 12, wherein the flexible portion is adapted to electrically isolate the connector part from the installation in use.

18. Apparatus for mounting a connector part of a connector for use in an underwater or severe environment to an installation, the apparatus being adapted to be secured at a radially inner region thereof to the connector part and at a radially outer region thereof to the installation, and comprising an electrically insulating component extending in the circumferential direction and interposed radially between the inner and outer securing regions for electrically isolating the connector part from the installation.

19. Apparatus as claimed in claim 1, in combination with the connector part.

20. A connector for use in an underwater or severe environment, comprising a first connector part adapted to be mounted to an installation, and a second connector part adapted to be mated with the first connector part to establish a connection, in combination with mounting apparatus as claimed in claim 1 for mounting the first connector part to the installation.
